(19) United States
(12) Patent Application Publication
(10) Pub. No.: US 2014/0136257 A1
(43) Pub. Date: May 15, 2014

(54) IN-MEMORY ANALYSIS SCENARIO BUILDER

(71) Applicant: SAP AG, Walldorf (DE)

(72) Inventor: JAMES MICHAEL AMULU, Bangalore (IN)

(73) Assignee: SAP AG, Walldorf (DE)

(21) Appl. No.: 13/672,701

(22) Filed: Nov. 9, 2012

(51) Int. Cl. G06Q 10/06

(52) U.S. Cl. CPC G06Q 10/067; G06Q 10/06311
USPC 705/7.15; 705/7.13

(57) ABSTRACT

In an embodiment, artifacts are received from one or more user interfaces in a development tool. The artifacts are associated with data stored in an in-memory database. Tasks associated with the artifacts are received from the one or more user interfaces in the development tool. Selection of one or more users associated with the analysis scenario is received from the one or more user interfaces. Each user is associated with a role and the one or more tasks. Generate an analysis scenario, based on the received artifacts, the received tasks and the received selection of users. Generate a deployment package by including deployment information to the generated analysis scenario.

### BACKGROUND

In a typical development environment, various types of complex business requirements are provided to the development team as business use cases. Business requirements or business use cases are generally in any form such as documents, notes, printed material, meeting discussions and the like. Such business requirements are provided by the sales team or product owners to the development team that develops application. In general, developers working on these business requirements use one of these documents or notes, to model and develop applications, corresponding to these business requirements. The transition of business requirement from the sales team to the development team, modeling based on the business requirement, and developing application is manually managed and decentralized. Therefore, managing and tracking various stages of the business requirement such as providing the requirement, modeling it, developing it and the like, is challenging.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an overview of an exemplary environment for an in-memory analysis scenario building, according to an embodiment.

FIG. 2 illustrates a user interface for creating an analysis scenario, according to an embodiment.

FIG. 3 illustrates a user interface for selecting design-time artifacts associated with the analysis scenario, according to one embodiment.

FIG. 4 illustrates a user interface for adding new design-time artifacts associated with the analysis scenario, according to one embodiment.

FIG. 5 illustrates a user interface for adding tasks to track the progress of the analysis scenario, according to one embodiment.

FIG. 6 illustrates a user interface for adding users, user groups, roles and privileges required for the analysis scenario, according to one embodiment.

FIG. 7 illustrates a user interface for adding instructions and attachments to the tasks associated with the analysis scenario, according to one embodiment.

FIG. 8 illustrates a user interface for displaying the generated analysis scenario in a development tool, according to one embodiment.

FIG. 9 illustrates a user interface for displaying the generated analysis scenario for review, according to one embodiment.

FIG. 10 illustrates a block diagram of a high level composition model of the in-memory analysis scenario builder, according to one embodiment.

FIG. 11 illustrates a block diagram indicating the components in a deployment package, according to one embodiment.

FIG. 12 illustrates a flow diagram of a method for an in-memory analysis scenario builder, according to one embodiment.

FIG. 13 is a block diagram of an exemplary computer system according to one embodiment.

### DETAILED DESCRIPTION

Embodiments of techniques for In-memory analysis scenario builder are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In-memory database typically relies on main memory for computation and storage. The in-memory database may be a relational database, an object oriented database or a hybrid of both. In-memory technology utilizes the maximum capabilities of the underlying hardware, to increase application performance. The possibility to perform fast calculations on in-memory data, allows the creation and use of applications that provide real-time business insight and fast ad-hoc reporting based on business requirements and business transaction data. Thus complex analytics can be performed based on business requirements. Information required for processing are available in the main memory, so computation and read operations can be executed in the main memory, without involving a hard disk input/output operation.

Traditionally, a database table is a two dimensional data structure with cells organized in rows and columns. However, in the typical in-memory database, memory organization is linear. In a linear memory organization, data may be stored as a row store or a column store. In a row store, the fields of every row in the table are stored in a row sequentially, whereas in a column store, the fields of a column are stored in a column, in contiguous memory locations. Row based storage and column based storage, store data and metadata that can be accessed by various components of the in-memory management system, such as any development tool, a query processing engine and the like.

Various development tools can be used, for development corresponding to the in-memory database. In one embodiment, the development tool may be a software application providing developers the facility to develop consoles, graphical user interfaces, web applications, build models and the like, by coding software program or visually modeling using an underlying prebuilt code. While designing an application corresponding to the in-memory database, developers use modeling tools such as front-end development tool to model applications based on the business requirement. Modeling tools enable the developers to work on the visual representation of the underlying physical data.

In one embodiment, the front-end development tool can be used for administration of the in-memory database and the developers can develop, manage and monitor the in-memory database. The front-end development tool provides a simple graphical user interface of the underlying in-memory database. In one embodiment, the front-end development tool can also be used at design-time to create models using metadata. Typically, the design-time is referred to as a design or development phase prior to compiling the software code and the metadata specifies data about the containers of the data.

In one embodiment, a model is a design-time artifact that provides a logical view of the metadata and its relationship, using the underlying tables in the in-memory database. Artifacts may be any by-product produced during the development of software, such as tables, views, functions, schema, models and the like. Artifacts used during the design phase of application development are generally referred to as design-time artifacts. In one embodiment, the design-time artifacts created by the front-end development tool are stored in the in-memory database tables as XML documents. Such stored objects are referred to as design-time objects. The graphical user interface of the front-end development tool provides developers with the available design-time artifacts, for the developers to build models based on the business requirements.

Typically, a business requirement includes a functionality, a feature, or a product required by a customer. For example, sales profit analysis can be a business requirement by the customer to view, drill-down and analyze sales and profit data in real-time. The sales profit analysis requirement may be provided to a product owner interfacing the customer. The business requirements are provided by the customer to the product owner in the form of series of documents, notes, discussions and the like. It is the responsibility of the product owner, to transition the gathered requirements for the sales profit analysis and provide it to the development team for modeling and building the specific business application.

In such a manual transition of business requirements to the development team, all the information is not captured and provided to the development team. Requirements provided to the individual developers are not captured and the progress of each team member is not tracked or recorded. Furthermore, modifications and enhancements to the business requirements are provided to the developers in an unorganized manner and are not tracked. Therefore, managing business requirements manually is challenging, decentralized, and not traceable. The development team has no mechanism to get an overview of the progress of the business requirement, from the first step of requirement gathering to the last step of product delivery. Therefore, the product delivered may not meet the actual business requirement.

Thus development teams require a mechanism to manage and track these business requirements by building an analysis scenario object in a front-end development tool. The analysis scenario object is a logical object, which holds reference to the selected design-time artifacts. The analysis scenario is built using various design-time artifacts such as models, tables, etc., that constitute a specific business requirement. In one embodiment, the analysis scenario comprises a set of design-time artifacts, a set of tasks corresponding to the included design-time artifacts, a set of users to execute the tasks and instructions associated with the tasks.

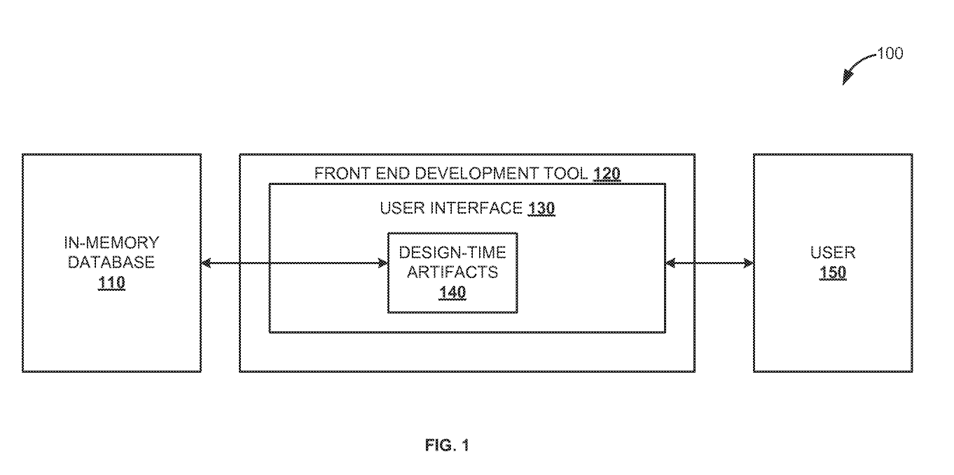

Design-time artifacts may be existing models, placeholder for new models, tables and the like. For example, sales profit analysis requirement includes various functional requirements such as sales data by region, distribution channel, etc. Sales profit analysis scenario can be modeled and developed by using the front-end development tool 120 as shown in 100 of FIG. 1, to meet the sales profit analysis business requirement. User 150 can build the sales profit analysis scenario by using the design-time artifacts 140 from the in-memory database 110, in the user interface 130 provided in the front end development tool 120. Tasks can be a job or activity corresponding to any of the design-time artifacts of the analysis scenario. Tasks corresponding to the analysis scenario enable tracking of the analysis scenario.

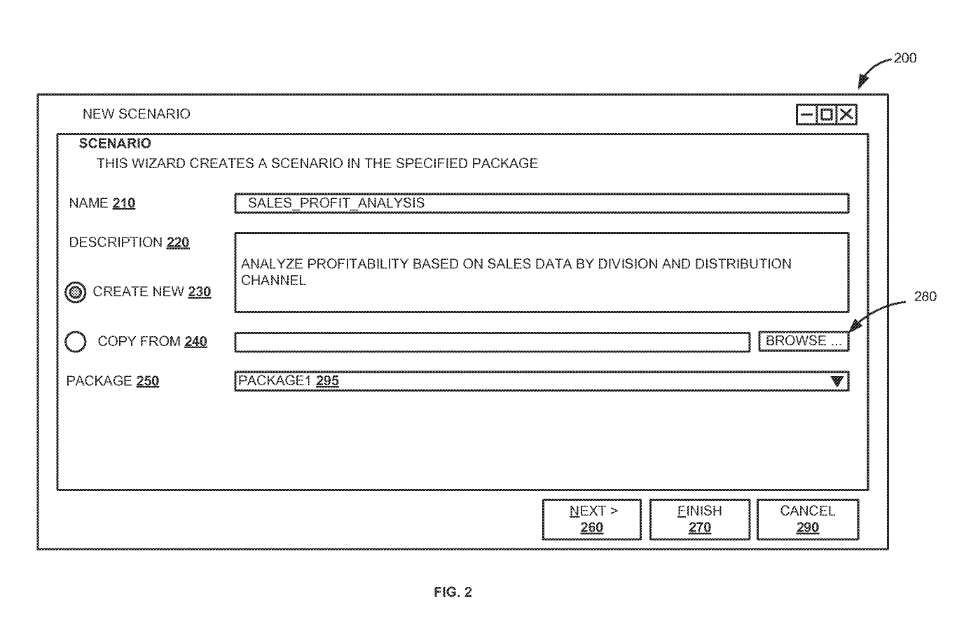

The analysis scenario is built corresponding to the business requirement. In one embodiment, the front-end development tool may be an interactive development wizard. FIG. 2 illustrates a user interface 200 for creating the analysis scenario, in an embodiment. The user interface 200 is provided in the front-end development tool, when the user initiates generation of the analysis scenario. The input fields such as ‘name’ 210, ‘description’ 220, ‘create new’ 230, ‘copy from’ 240, ‘package’ 250 and ‘browse’ 280 are provided in the user interface 200. A unique name to the analysis scenario can be provided in the ‘name’ 210 field. The name can be a combination of alphabets, numbers, symbols, and other characters. For example, ‘sales_profit_analysis’ is provided as the name of the analysis scenario in the ‘name’ 210 field. ‘Description’ 220 is used to provide a brief description of the analysis scenario. For example, ‘analyze profitability based on sales data by division and distribution channel’ is provided as the description in the ‘description’ 220 field.

User may select the option ‘create new’ 230 to generate the analysis scenario from scratch or select the option ‘copy from’ 240 to copy an existing analysis scenario. When the user selects the ‘create new’ 230 option, ‘sales_profit_analysis’ scenario can be generated based on the inputs received such as design-time artifacts, tasks and the like, from the various user interfaces rendered subsequently in the front-end development tool. The analysis scenario holds reference to the design-time artifacts selected and therefore duplicate design-time artifacts are not created. In one embodiment, the analysis scenario can be generated without receiving the inputs initially and at a later point of time the analysis scenario can be edited to include the required inputs such as design-time artifacts, tasks and the like. The edit operation can be an iterative approach, where the inputs can be iteratively added or removed based on the business requirement.

When the user selects the ‘copy from’ 240 option, user can select any of the existing analysis scenarios by selecting the ‘browse’ 280 option. When the ‘browse’ 280 option is selected, user is provided with a window, listing all the existing scenarios and the user can choose one of the existing analysis scenarios from the list. The selected analysis scenario is copied and created with the name specified in the ‘name’ 210 field as anew analysis scenario. User has the option to edit and modify the information in the new analysis scenario.

User can select a package in the ‘package’ 250 drop down. In one embodiment, package is a structured grouping of a set of related information objects. For example, sales tables, sales schema, sales models and the like can be grouped in a ‘sales package’. The analysis scenario generated is organized in the package selected from the ‘package’ 250 drop down. For example in the ‘package’ 250 option, ‘package1’ 295 is selected and accordingly the analysis scenario ‘sales_profit_analysis’ will be generated in the ‘package1’ 295 package. User can choose to select the ‘next’ 260 option and proceed to the next user interface to select the design-time artifacts or click on ‘finish’ 270 option to complete the analysis scenario generation.

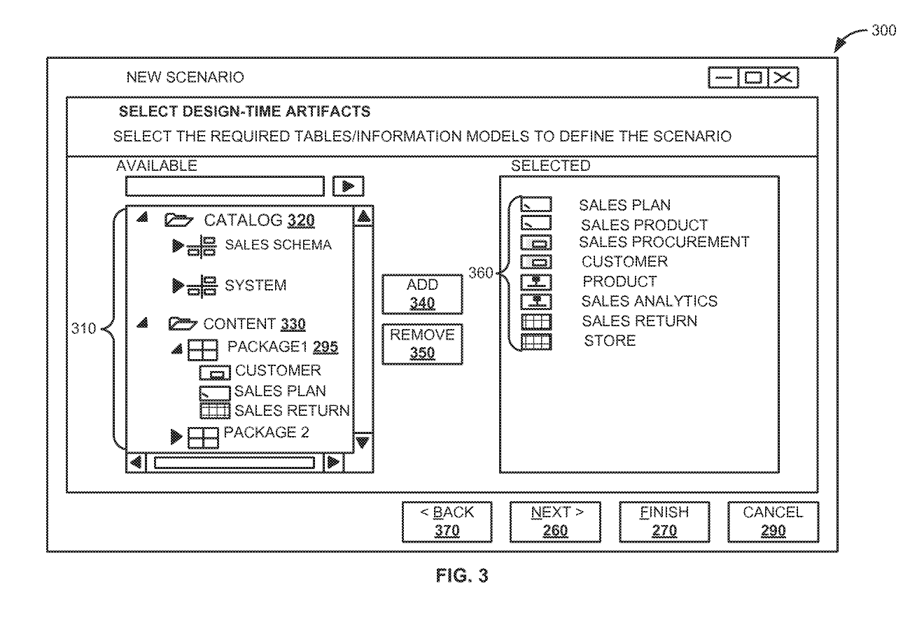

FIG. 3 illustrates a user interface 300 for selecting the design-time artifacts associated with the analysis scenario, in an embodiment. The user interface 300 is provided in the front-end development tool when the user selects the ‘next’ 260 option in the user interface 200 shown in FIG. 2. In one embodiment, the user is provided with a list of available design-time artifacts 310 grouped within nodes in the form of hierarchical trees. For example, ‘catalog’ node 320, ‘content’ node 330, etc., provide a list of design-time artifacts in the form of the hierarchical tree.

In one embodiment, catalog node represents data structures, tables, data and the like which correspond to a data dictionary of the in-memory database. Data dictionary is also referred to as a metadata repository. For example the ‘catalog’ node 320 comprises some of the design-time artifacts such as the physical tables, views, list of schemas and the like. In one embodiment, content node represents a design-time repository which holds all the models created with the front-end development tool. For example, ‘content’ 330 comprise models such as sales model, profit model and the like. Models are organized in the package in the contents node. These models are stored in the tables in the in-memory database. These tables are visible in the ‘catalog’ 320 node.

User can choose the required design-time artifacts from the list of available design-time artifacts 310 and select ‘add’ 340 option to add these selected design-time artifacts 360 to the selected window. The list of available design-time artifacts 310 include various types of models such as ‘sales plan’ analytical model, ‘customer’ calculation model, ‘product’ attribute model and ‘sales return’ table along with their respective icon representations. The functionality of the models can be defined and designed in the front-end development tool. For example, ‘sales plan’ analytical model may include attributes and measurable data from the in-memory database tables that can be used for computations. ‘Product’ attribute model may include only attributes from the in-memory database tables. For example, ‘customer’ and ‘sales plan’ models are added to the selected window, for the ‘sales_profit_analysis’ scenario. User can choose to select any design-time artifact from the selected window 360 and select ‘remove’ 350 option to remove the selected design-time artifact. The list of design-time artifacts in the selected window is included in the analysis scenario that is being generated. User can choose to select the ‘next’ 260 option and proceed to the next user interface to add new design-time artifacts or click on ‘finish’ 270 option to complete the analysis scenario generation. User can also choose to select the ‘back’ 370 option and navigate to the previous user interface 200 to modify inputs if any.

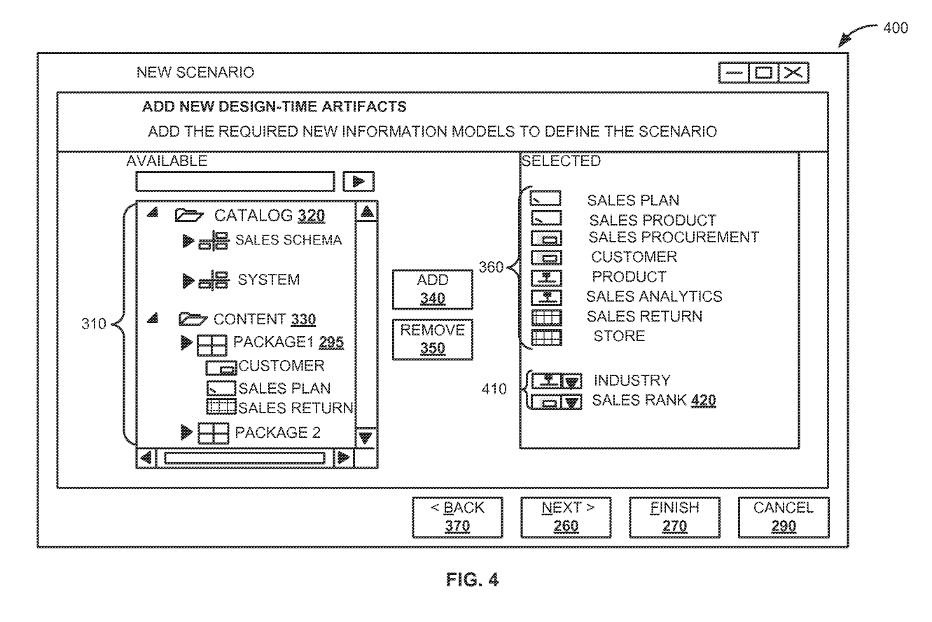

FIG. 4 illustrates a user interface 400 for adding new design-time artifacts associated with the analysis scenario, in an embodiment. The user interface 400 is provided in the front-end development tool, when the user selects the ‘next’ 260 option in the user interface 300. In the selected window, user can create the new design-time artifacts 410 required for the completion of the analysis scenario and thus the business requirement. Placeholders for the new design-time artifacts 410 are created in the selected window and at a later point of time developers can add tasks to work and develop the new design-time artifacts. For example, ‘sales rank’ 420 can be one of the new model created for the sales profit analysis scenario in the selected window. ‘Sales rank’ 420 model created can be developed at a later point of time by adding tasks corresponding to the development of the ‘sales rank’ 420 model. User can choose to select the ‘next’ 260 option and proceed to the next user interface to add tasks to track the progress of the analysis scenario or click on the ‘finish’ 270 option to complete the analysis scenario generation. User can also choose to select the ‘back’ 370 option to navigate to the previous user interface 300 to ‘add’ or ‘remove’ the design-time artifacts.

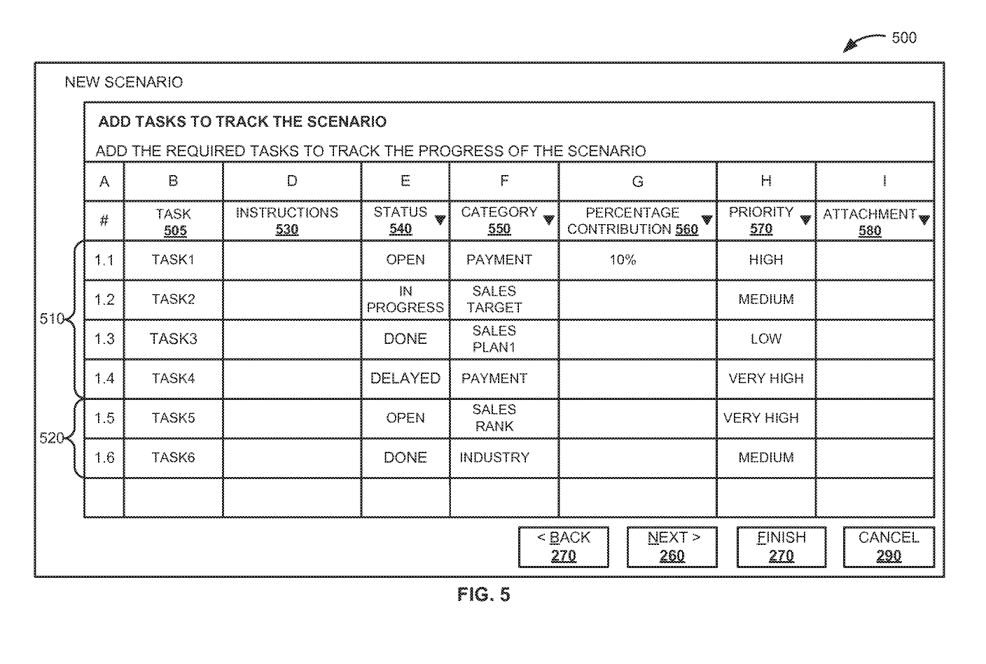

FIG. 5 illustrates a user interface 500 for adding tasks to track the progress of the analysis scenario, in an embodiment. The user interface 500 is provided when the user selects the ‘next’ 260 option in the user interface 400. In one embodiment, a default set of tasks associated with a template is provided in the user interface 500. General set of tasks are grouped in the template for ease of use. Users can edit, modify, add or remove tasks in the template. In another embodiment, users can create a new set of required tasks to track the progress of the analysis scenario.

Tasks are associated with the models of the analysis scenario. The progress of the analysis scenario is tracked based on the data input corresponding to every task. For example the first set of tasks 510 includes tasks such as ‘task1’, ‘task2’, ‘task3’ and ‘task 4’ associated with the selected design-time artifacts 360. The second set of tasks in task set 520 includes tasks such as ‘task5’, ‘task6’ and the like, associated with the new set of design-time artifacts 410. Some examples of tasks associated with sales profit analysis scenario includes validate sales data, build web report for profit and compute actual sales return.

The tasks created in the first set of tasks 510 and the second set of tasks 520, includes field such as ‘instructions’ 530, ‘status’ 540, ‘category’ 550, ‘percentage contribution 560, ‘priority’ 570 and ‘attachment’ 580. The ‘status’ 540 field represents the status associated with the task. For example ‘status’ 540 field can have statuses such as ‘open’, ‘in progress’, ‘delayed’, and ‘completed’. The ‘category’ 550 field represents the specific category of the task, For example the ‘category’ 550 field can have categories such as sales payment and sales calculation.

‘Percentage contribution’ 560 represents a progress indicator in numeral indicating the percentage contribution of the task to the overall analysis scenario completion. Progress indicator can be represented in any metric or graphical representation corresponding to the current progress of the task such as percentage, graphical progress bar and the like. For example the ‘percentage contribution’ 560 corresponding to ‘task1’ can be 10%, In one embodiment, the ‘percentage contribution’ can also be represented as a status where each status is associated with the corresponding numeral. ‘Priority’ 570 indicates the priority of the task in the analysis scenario such as high, medium, low and the like. For example the ‘priority’ 570 corresponding to ‘task1’ can be high. User can choose to select the ‘next’ 260 option and proceed to the next user interface to add user, user group, role and analytic privilege or click on ‘finish’ 270 option to complete the analysis scenario generation. User can also choose to select ‘back’ 370 option to navigate to the previous user interface 400 to ‘add’ or ‘remove’ new design-time artifacts.

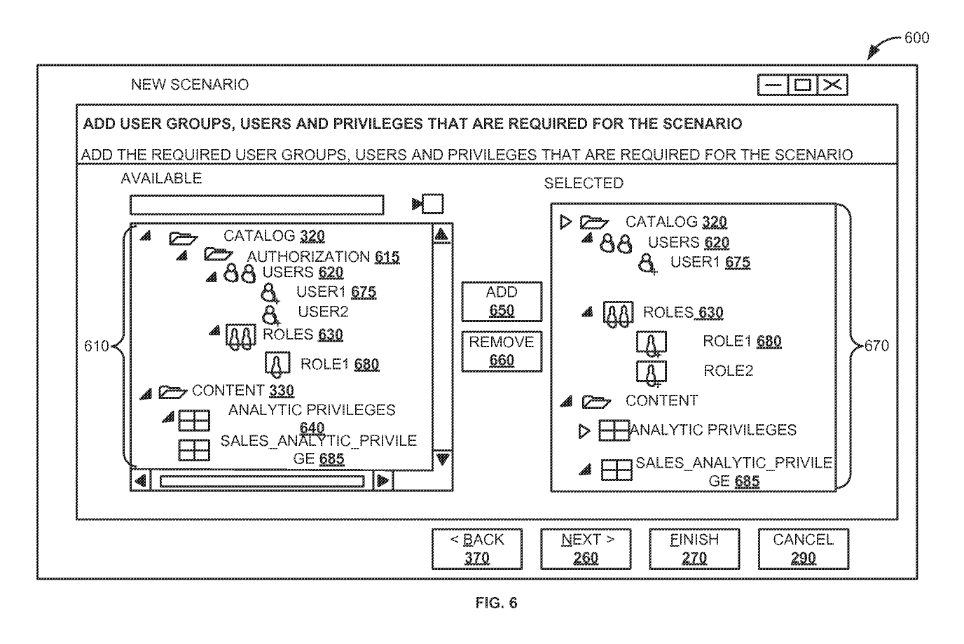

FIG. 6 illustrates a user interface 600 for adding users, user groups, roles and privileges required for the analysis scenario, in an embodiment. The user interface 600 is provided when the user selects the ‘next’ 260 option in the user interface 500, as shown in FIG. 5. In one embodiment a set of available users, user groups, roles and privileges 610 are displayed in the available window in the corresponding node in the hierarchical tree. For example, node ‘authorization’ 615 in node ‘catalog’ 320, provides a list of users 620, and roles 630.

List of users, user groups, roles, etc., created and stored in the in-memory database are retrieved and provided in the available window as the set 610. Roles 630 node provides the list of roles, where each role defines a set of access rights such as read, write and the like privileges. In one embodiment, an administrator associates the user and the role with the analytic privilege. ‘Analytic privileges’ 640 provides the available set of analytic privileges. For example ‘user1’ 675 and role1’ 680 are assigned to the ‘sales_analytic_privilege’ 685 analytic privilege. ‘User1’ with ‘sales_analytic_privilege’ 685 can create, modify and access selected content in the front-end development tool based on the privileges defined in ‘role1’ 680.

User can choose the required users, user groups, roles and analytic privileges from the set 610 in the available window and select ‘add’ 650 option to add the selected items to the selected set of items 670. User can choose to select any item from the selected set of items 670 and select ‘remove’ 660 option to remove the selected item. The list of users, roles and analytic privileges in the selected set of items 670 arc included in the ‘sales_profit_analysis’ scenario that is being generated. For example, ‘sales_analytic_privilege’ 685, ‘user1’ 675 with ‘role1’ 680 are included in the ‘sales_profit_analysis’ scenario. User can choose to select the ‘next’ 260 option and proceed to the next user interface to add instructions to tasks or click on ‘finish’ 270 option to complete the analysis scenario generation. User can also choose to select ‘back’ 370 option to navigate to the previous user interface 500 to ‘add’ or ‘remove’ tasks.

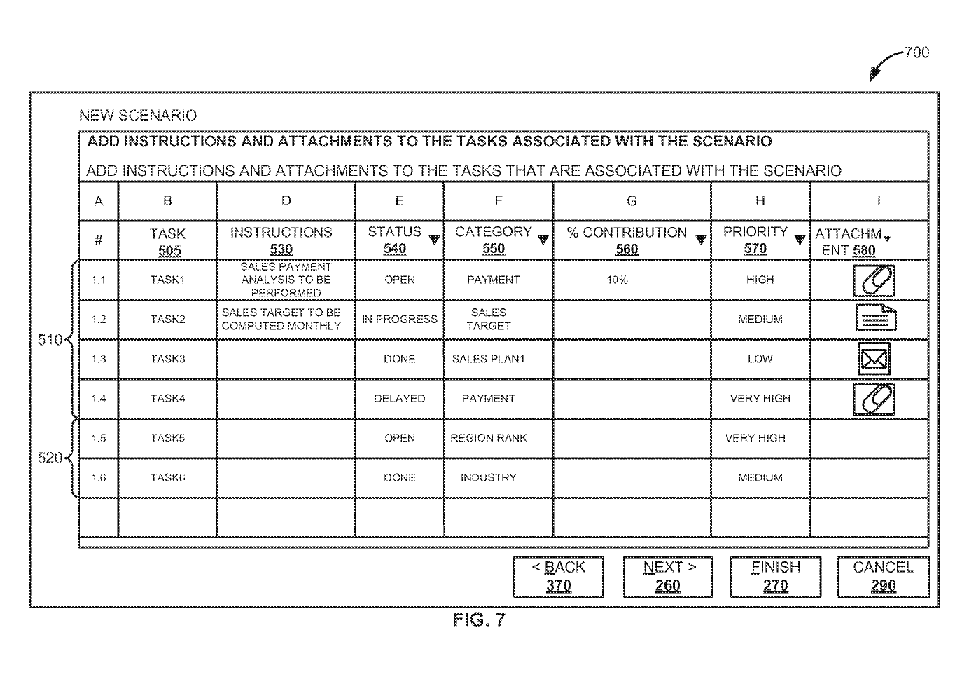

FIG. 7 illustrates a user interface 700 for adding instructions and attachments to the tasks associated with the analysis scenario, in an embodiment. The user interface 700 is provided in the front-end development tool, when the user selects the ‘next’ 260 option in the user interface 600. Users assigned to work on the specific task can be provided instruction in the ‘instructions’ 530 field. For example, a developer assigned to work on ‘task1’ can be provided instructions or notes based on the business requirement, in the ‘instructions’ 530 field.

Also, the user assigned to work on the specific task can be provided information related to the business requirement in the form of an attachment in the ‘attachment’ 580 field. Attachments related to business requirements can be in the form of documents, mils, recordings, voice tags and the like. User can select ‘finish’ 270 option to complete the analysis scenario generation. User can also choose to select the ‘back’ 370 option to navigate to the previous user interface 600 to ‘add’ or ‘remove’ any of the users, roles and privileges. When the user selects ‘finish’ 270 option the ‘sales_profit_analysis’ scenario is generated including the inputs received such as design-time artifacts, tasks, users, roles, privileges, from the corresponding user interfaces. The ‘sales_profit_analysis’ scenario generated is stored in the table in the in-memory database.

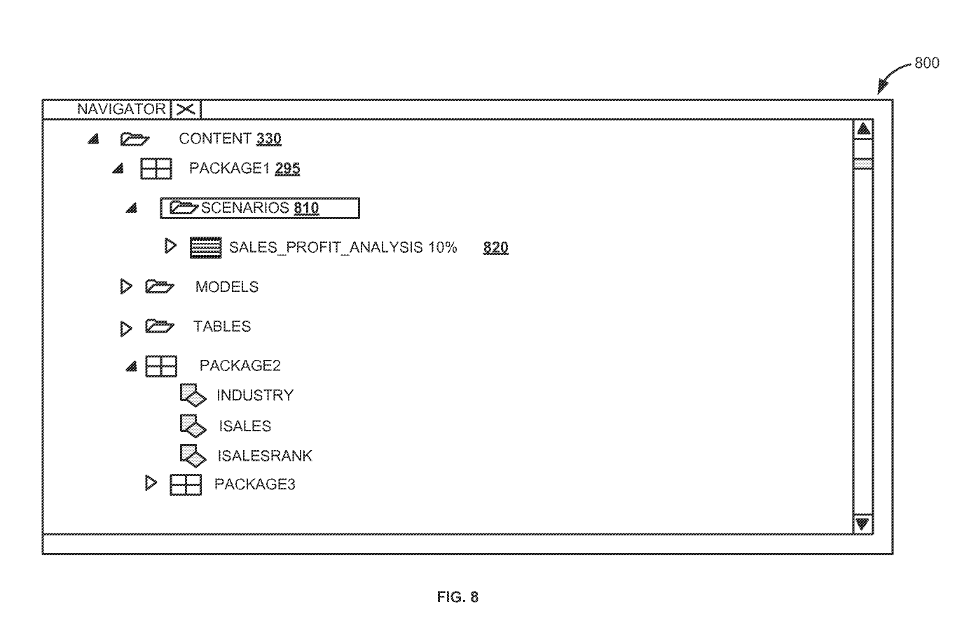

FIG. 8 illustrates a user interface 800 for displaying the generated analysis scenario in the front-end development tool, in an embodiment. The user interface 800 is provided in the front-end development tool, when the user selects the ‘scenarios’ 810 node in the front-end development tool. In one embodiment, the ‘sales_profit_analysis’ 820 scenario is available in the front-end development tool in the ‘content’ 330 node in ‘package1’ 295. Developers working using the front-end development tool can open the ‘sales_profit_analysis’ 820 scenario to view and work on the tasks assigned to them. Any developer working on a specific task can update the ‘percentage contribution’ of the specific task by editing the ‘sales_profit_analysis’ 820 scenario.

For example, the developer after completing substantial amount of work in ‘task1’ can update the ‘percentage contribution’ 560 field corresponding to ‘task1’ as 10%, in the user interface 700 of FIG. 7. Based on the values input by the developers in the ‘percentage contribution’ field an overall progress indicator is computed and displayed along with the ‘sales_profit_analysis’ 820 scenario in the user interface 800. The overall progress indicator is computed by performing aggregation on the values input by the developers. Accordingly the overall progress indicator is computed as 10% and is displayed along with the ‘sales_profit_analysis’ 820 scenario. In one embodiment, the developers can update the ‘percentage contribution’ with statuses such as ‘open’, ‘in progress’ and the like, where numeric values can be internally associated with each of the statuses. Based on the status updated by every user, overall progress indicator is computed and displayed along with the ‘sales_profit_analysis’ 820 scenario. Based on the ‘percentage completion’ received corresponding to every task the overall progress of the analysis scenario is computed and displayed. Therefore the progress of the analysis scenario can be tracked.

In one embodiment, the developer can open the ‘sales_profit_analysis’ 820 scenario in the front-end development tool and edit the analysis scenario to modify, add or delete any values. For example, the developer can open sales_profit_analysis’ 820 scenario and navigate to the user interface 300 of FIG. 3 and select ‘sales schema’ and add it to the selected design-time artifacts 360 of FIG. 3. Further, user can navigate to user interface 600 of FIG. 6 and select ‘role2’ and remove it from the selected set of items 670 of FIG. 6. The edited sales_profit_analysis' 820 scenario can be saved by selecting ‘finish’ 270 option.

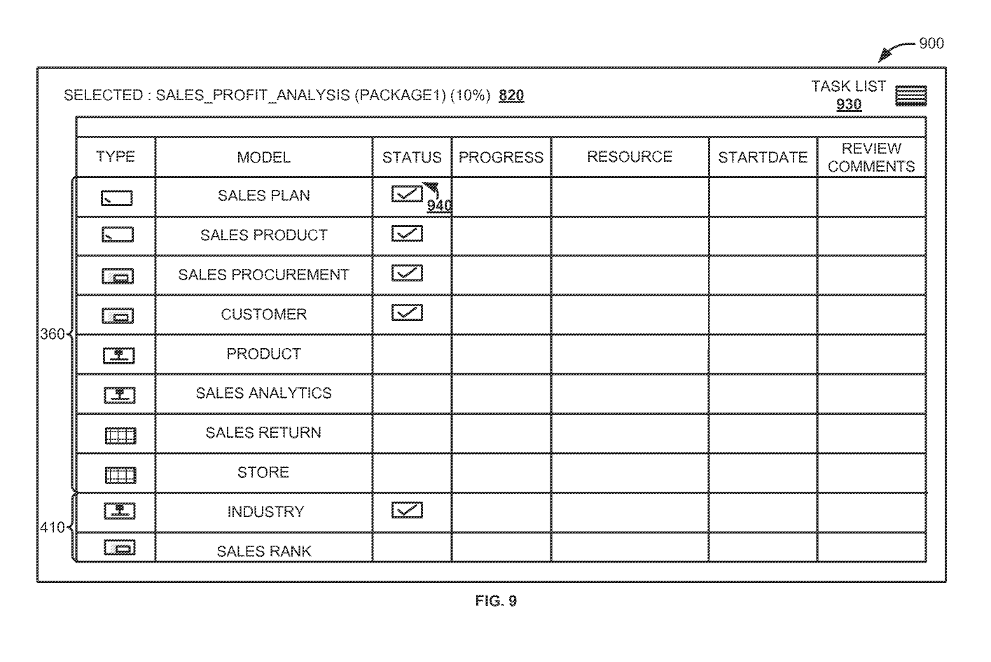

FIG. 9 illustrates a user interface 900 for displaying the generated analysis scenario for review, in an embodiment. The user interface 900 is provided when the user selects ‘sales_profit_analysis’ scenario 820 of FIG. 8. The design-time artifacts selected and added while generation of the ‘sales_profit_analysis’ scenario is displayed for the user to review. For example, the selected design-time artifacts 360 and the new set of design-time artifacts 410 are displayed for the user to review. User can review and choose to edit the ‘sales_profit_analysis’ 820 scenario by adding or removing the design-time artifacts by navigating to the respective user interfaces in the front-end development tool.

In one embodiment, the statuses of the design-time artifacts are displayed along with the design-time artifacts in the user interface 900. The status can be displayed in any of the representation such as numeric value, graphical icon, and progress indicator. For example the graphical icon 940 corresponding to the sales plan model, indicates a ‘complete’ status. The statuses corresponding to all the models in the ‘sales_profit analysis’ 820 scenario is used to compute the overall progress of the ‘sales_profit_analysis’ 820 scenario. The computed overall progress 820 corresponding to the ‘sales_profit_analysis’ scenario is displayed in the user interface 900. In one embodiment, if the computed overall progress corresponding to the ‘sales_profit_analysis’ scenario is 100%, the ‘sales_profit_analysis’ scenario is automatically turned to completion. Accordingly, the ‘sales_profit_scenario is indicated as completed in the user interface 800 and 900. By selecting the ‘task list’ 930 option, the first set of tasks 510 and the second set of tasks 520 added while generation of the ‘sales_profit_analysis’ 820 scenario, is displayed in a user interface. User can choose to review the tasks displayed.

In one embodiment, the generated analysis scenario can be stored in versions. Versions are represented as unique identifiers in increasing order and indicate the new modifications to the generated analysis scenario. The versions associated with the analysis scenarios can be tracked and retrieved for display. In one embodiment, the generated analysis scenario can be upgraded to the version specified. The analysis scenario version lifecycle can be managed and tracked. The front-end development tool provides an option to search for various entities in the in-memory database such as design-time artifacts and scenarios.

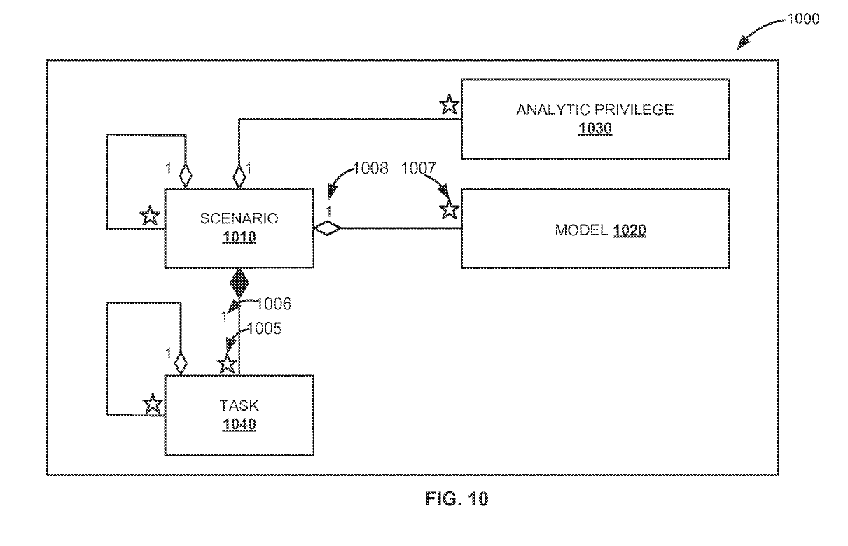

FIG. 10 illustrates a block diagram 1000 indicating a high level composition model of the in--memory analysis scenario builder, in an embodiment. Composition model is a unified modeling language (UML) representation indicating the composite aggregation relationship between classes or entities. Composite relationship represents a whole-part relationship. Block diagram 1000 includes various entities such as scenario 1010, analytic privilege 1030, model 1020 and task 1040. In one embodiment, block diagram 1000 corresponds to the in-memory storage repository. File represents storage type in the in-memory database where that task can be stored. The composite aggregation relationship is designed for each of the entities and accordingly the high level composition model is built.

In one embodiment, the scenario 1010 and the task 1040 represents the composite relationship. In this composite relationship, the task 1040 cannot exist independently without the scenario 1010. The notations 1005 and 1006 specified in the composite relationship indicate that many tasks can constitute one scenario. In one embodiment, the scenario 1010 and model 1020 represents the aggregation relationship. In this aggregation relationship, the model 1020 can exist independently without the scenario 1010. The notations 1007 and 1008 specified in the aggregation relationship indicate that many model objects can constitute one scenario. Similarly composite aggregation relationship is designed for each of the entities and accordingly the high level composition model is built.

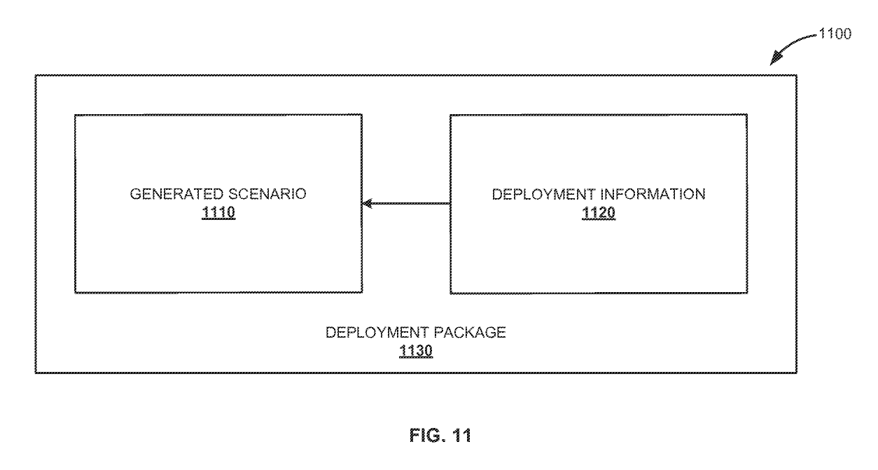

In one embodiment, scenario 1010, analytic privilege 1030 and model 1020 constitutes transportable content. Transportable content can be ported to any other development tool or environment. Transport may include the act of importing, exporting, migrating, copying and the like. In one embodiment, the scenario 1010 can be transported by exporting the generated analysis scenario. Transporting the generated analysis scenario can be performed by generating a deployment package as illustrated in FIG. 11, FIG. 11 illustrates a block diagram 1100 indicating the components in the deployment package, in an embodiment. The generated analysis scenario 1110 is exported by including deployment information 1120 to the generated analysis scenario 1110. Deployment information 1120 can be a group of transportable objects for content delivery. For example, to transport the design-time artifacts that are stored in the source in-memory database to target database, deployment information is required. Deployment information 1120 may include properties such as vendor information, database information, etc., that are required to transport the design-time artifacts stored in the source in-memory database to the target database.

The generated analysis scenario 1110 along with the deployment information 1120 constitutes the deployment package 1130. In one embodiment, the deployment package 1130 is available for import in the target database instance in the form of the transportable file format such as, for example, GZIP and TGZ. Based on the properties specified in the deployment information 1120, the deployment package 1130 can be imported to the target database. Accordingly the generated analysis scenario is transported to the target database.

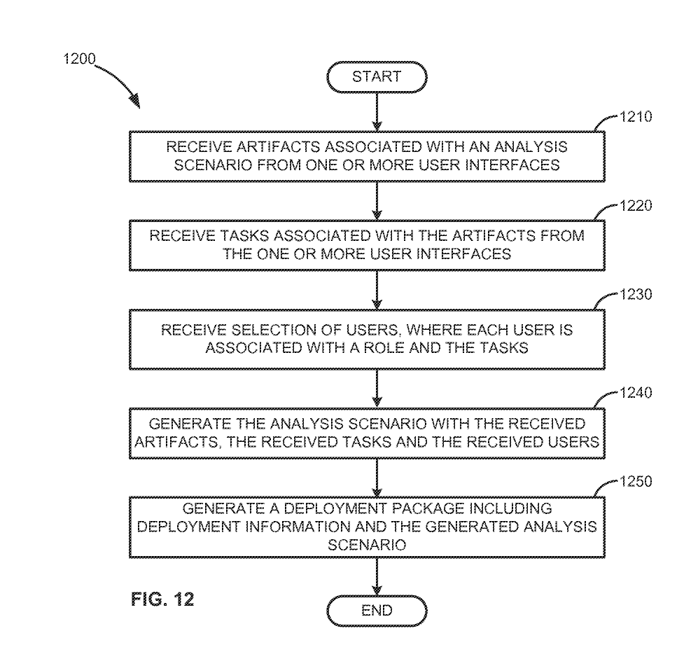

FIG. 12 illustrates a flow diagram 1200 of a method for an in-memory analysis scenario builder, in an embodiment. The front-end development tool may be an interactive development tool to receive inputs such as design-time artifacts, tasks and the like, to generate the analysis scenario. In 1210, design-time artifacts associated with the analysis scenario are received from one or more user interfaces in the front-end development tool. Tasks represent the job and correspond to the design-time artifacts selected. At 1220, tasks associated with the design-time artifacts are received from the one or more user interfaces in the front-end development tool. Users are associated with roles, where each role defines a set of access rights such as read, write and the like privileges.

At 1230, selection of users from the one or more user interfaces is received, where the selected user is associated with a role and the task. For example, receiving selection of ‘user1’ from the user interface, where ‘user1’ has ‘role1’ and ‘user ’ is associated with ‘task1’. At 1240, based on the received design-time artifacts, the received tasks and the received user selection, analysis scenario is generated in the front-end development tool. The generated analysis scenario can be packaged to be deployed in various environments such as another font-end development tool or a custom development environment. At 1250, a deployment package can be generated by including deployment information and the generated analysis scenario. Deployment information may include properties such as vendor information, database information and the like that are required to transport the generated analysis scenario stored in the source in-memory database to the target system.

The various embodiments described above have a number of advantages. For example, the progress of the individual task entries can be captured and accordingly the overall progress of the analysis scenario can be computed and tracked. This gives the development team a mechanism to manage and track the progress of analysis scenario and thus the business requirement. Developers in the development team are able to collaborate and work in an organized way. Data is captured at every stage of the generation of the analysis scenario and therefore data is centralized. The scenario object generated holds reference to the selected design-time artifacts and therefore duplicate objects are not created. The analysis scenario generation reduces the time taken to manage and track the business requirement by half.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

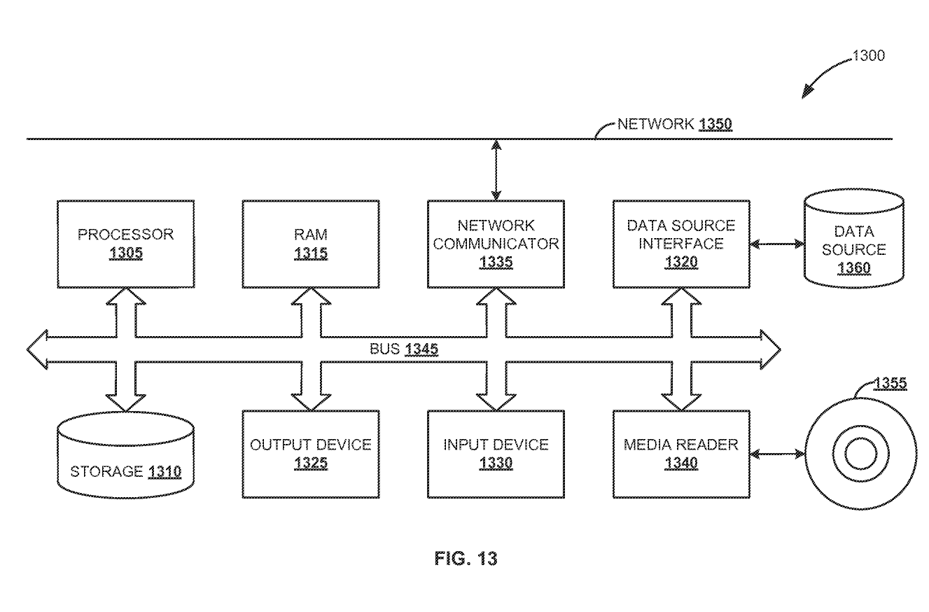

FIG. 13 is a block diagram of an exemplary computer system 1300. The computer system 1300 includes a processor 1305 that executes software instructions or code stored on a computer readable storage medium 1355 to perform the above-illustrated methods. The processor 1305 can include a plurality of cores. The computer system 1300 includes a media reader 1340 to read the instructions from the computer readable storage medium 1355 and store the instructions in storage 1310 or in random access memory (RAM) 1315. The storage 1310 provides a large space for keeping static data where at least some instructions could be stored for later execution According to some embodiments, such as some in-memory computing system embodiments, the RAM 1315 can have sufficient storage capacity to store much of the data required for processing in the RAM 1315 instead of in the storage 1310. In some embodiments, all of the data required for processing may be stored in the RAM 1315. The stored instructions may be further compiled to generate other representations of the instructions and dynamically stored in the RAM 1315. The processor 1305 reads instructions from the RAM 1315 and performs actions as instructed. According to one embodiment, the computer system 1300 further includes an output device 1325 (e.g., a display) to provide at least some of the results of the execution as output including, but not limited to, visual information to users and an input device 1330 to provide a user or another device with means for entering data and/or otherwise interact with the computer system 1300. Each of these output devices 1325 and input devices 1330 could be joined by one or more additional peripherals to further expand the capabilities of the computer system 1300. A network communicator 1335 may be provided to connect the computer system 1300 to a network 1350 and in turn to other devices connected to the network 1350 including other clients, servers, data stores, and interfaces, for instance. The modules of the computer system 1300 are interconnected via a bus 1345. Computer system 1300 includes a data source interface 1320 to access data source 1360. The data source 1360 can be accessed via one or more abstraction layers implemented in hardware or software. For example, the data source 1360 may be accessed by network 1350. In some embodiments the data source 1360 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a mark-up language (e.g., XML data), transactional data, unstructured data (e.g., text files, screen scrapings), hierarchical data. (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. An article of manufacture including a non-transitory computer readable storage medium to tangibly store instructions, which when executed by a computer, cause the computer to:
from one or more user interfaces of an development tool, receive a plurality of design-time artifacts associated with an analysis scenario, wherein the design-time artifacts are associated with data stored in an in-memory database and the analysis scenario corresponds to a business requirement;
receive one or more tasks associated with the design-time artifacts from the one or more user interfaces;
receive selection of one or more users associated with the analysis scenario from the one or more user interface, wherein each user is associated with a role and the one or more tasks;
generate the analysis scenario in the development tool based on the received design-time artifacts, the received tasks and the received selection of users; and
generate a deployment package for transporting the generated analysis scenario, wherein the deployment package comprises deployment information and the generated analysis scenario.

2. The article of manufacture of claim 1, further comprising instructions which when executed by the computer further causes the computer to:
in response to a user selection of the generated analysis scenario, display the received design-time artifacts;
receive an input to update the received design-time artifacts;
update the generated analysis scenario based on the received input; and
store the updated analysis scenario in the in-memory database.

3. The article of manufacture of claim 1, further comprising instructions which when executed by the computer further causes the computer to:
in response to a user selection, display the received one or more tasks and the received selection of one or more users of the generated analysis scenario;
receive an input to update the received one or more tasks and the received selection of one or more users;
update the generated analysis scenario based on the received input; and
store the updated analysis scenario in the in-memory database.

4. The article of manufacture of claim 1, further comprising instructions which when executed by the computer further causes the computer to:
receive a progress indicator corresponding to the one or more tasks;
based on the received progress indicator, compute an overall progress indicator corresponding to the analysis scenario; and
display the analysis scenario with the overall progress indicator.

5. The article of manufacture of claim 1, further comprising instructions which when executed by the computer further causes the computer to:
receive a selection of the generated analysis scenario in the development tool;
in response to a user selection, display one or more of the received design-time artifacts, received one or more tasks and the received selection of one or more users of the generated analysis scenario;
receive an input to update one or more of the received design-time artifacts, the received one or more tasks and the received selection of one or more users;
update the generated analysis scenario based on the received input; and
generate a new analysis scenario in the in-memory database based on the update of the generated analysis scenario.

6. The article of manufacture of claim 1, wherein the design-time artifact comprises one or more of models, tables and schemas.

7. A computer implemented method for in-memory analysis scenario builder, the method comprising:
from one or more user interfaces of an development tool, receiving a plurality of design-time artifacts associated with an analysis scenario, wherein the design-time artifacts are associated with data stored in an in-memory database;
receiving one or more tasks associated with the design-time artifacts from the one or more user interfaces;
receiving selection of one or more users associated with the analysis scenario from the one or more user interface, wherein the users are associated with a role and the one or more tasks;
generating the analysis scenario in the development tool with the received design-time artifacts, the received tasks and the received selection of users; and
storing the generated analysis scenario in the in-memory database.

8. The method of claim 7, further comprising:
in response to a user selection of the generated analysis scenario, displaying the received design-time artifacts;
receiving an input to update the received design-time artifacts;
updating the generated analysis scenario based on the received input; and
storing the updated analysis scenario in the in-memory database.

9. The method of claim 7, further comprising:
in response to a user selection, displaying the received one or more tasks and the received selection of one or more users of the generated analysis scenario;
receiving an input to update the received one or more tasks and the received selection of one or more users;
updating the generated analysis scenario based on the received input; and
storing the updated analysis scenario in the in-memory database.

10. The method of claim 7, further comprising:
receive a progress indicator corresponding to the one or more tasks;
based on the received progress indicator, compute an overall progress indicator corresponding to the analysis scenario; and
display the analysis scenario with the overall progress indicator.

11. The method of claim 7, further comprising:
receiving a selection of the generated analysis scenario in the development tool;
in response to a user selection, displaying one or more of the received design-time artifacts, received one or more tasks and the received selection of one or more users of the generated analysis scenario;
receiving an input to update one or more of the received design-time artifacts, the received one or more tasks and the received selection of one or more users;
updating the generated analysis scenario based on the received input; and
generating a new analysis scenario in the in-memory database based on the updation of the generated analysis scenario.

12. The method of claim 7, wherein the design-time artifact comprises one or more of models, tables and schemas.

13. The method of claim 7, further comprising:
generate a deployment package for transporting the generated analysis scenario, wherein the deployment package comprises deployment information and the generated analysis scenario.

14. A computer system for in-memory analysis scenario builder, comprising:
a computer memory to store program code; and
a processor to execute the program code to:
from one or more user interfaces of an development tool, receive a plurality of design-time artifacts associated with an analysis scenario, wherein the design-time artifacts are associated with data stored in an in-memory database;
receive one or more tasks associated with the design-time artifacts from the one or more user interfaces;
receive selection of one or more users associated with the analysis scenario from the one or more user interface, wherein each user is associated with a role and the one or more tasks;
generate the analysis scenario in the development tool with the received design-time artifacts, the received tasks and the received selection of users.

15. The system of claim 14, wherein the processor further executes the program code to:
in response to a user selection of the generated analysis scenario, display the received design-time artifacts;
receive an input to update the received design-time artifacts;
update the generated analysis scenario based on the received input; and
store the updated analysis scenario in the in-memory database.

16. The system of claim 14, wherein the processor further executes the program code to:
in response to a user selection, display the received one or more tasks and the received selection of one or more users of the generated analysis scenario;
receive an input to update the received one or more tasks and the received selection of one or more users;
update the generated analysis scenario based on the received input; and
store the updated analysis scenario in the in-memory database.

17. The system of claim 14, wherein the processor further executes the program code to:
receive a progress indicator corresponding to the one or more tasks;
based on the received progress indicator, compute an overall progress indicator corresponding to the analysis scenario; and
display the analysis scenario with the overall progress indicator.

18. The system of claim 14, wherein the processor further executes the program code to:
receive a selection of the generated analysis scenario in the development tool;
in response to a user selection, display one or more of the received design-time artifacts, received one or more tasks and the received selection of one or more users of the generated analysis scenario;
receive an input to update one or more of the received design-time artifacts, the received one or more tasks and the received selection of one or more users;
update the generated analysis scenario based on the received input; and
generate a new analysis scenario in the in-memory database based on the updation of the generated analysis scenario.

19. The system of claim 14, wherein the design-time artifact comprises one or t core of models, tables and schemas.

20. The system of claim 14, further comprising:
generate a deployment package for transporting the generated analysis scenario, wherein the deployment package comprises deployment information and the generated analysis scenario.
